(19) United States
(12) Patent Application Publication
(10) Pub. No.: US 2006/0208497 A1
(43) Pub. Date: Sep. 21, 2006

(54) Worry-Free Lock Device

(75) Inventors: James Joseph DelGrosso, Ashburn, VA (US); Lloyd Goodnow, Red Hook, NY (US); Scott McLean, Lagrangeville, NY (US)

Correspondence Address: JAMES J. DELGROSSO, 20821 GLADWYNE CT, ASHBURN, VA, 20147, US

(73) Assignee: James Joseph DelGrosso, Ashburn, VA (US)

(21) Appl. No.: 11/164,775

(22) Filed: Dec. 5, 2005

Related U.S. Application Data
(60) Provisional application No. 60/593,067, filed on Dec. 6, 2004.

(51) Int. Cl. E05C 1/02

(52) U.S. Cl. 292/137

(57) ABSTRACT

A common method to operate a door is to have a door knob on the door connected to a latch which slides through an opening in the door into another opening in the door jamb. When the door is closed the latch extends from the door through the strike plate and into the door jamb. To open the door the latch must slide away from the door jamb past the strike plate and into an opening in the door (usually accomplished by turning the door knob, pressing a lever handle or turning a key). By inserting a pin through the latch when the door is closed, the latch cannot slide away from the door jamb and the door cannot be opened.

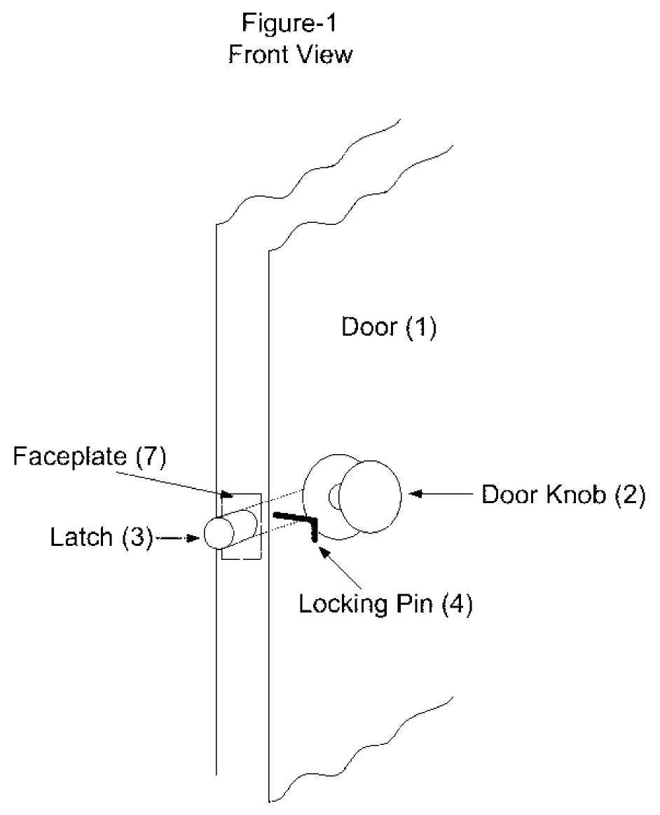

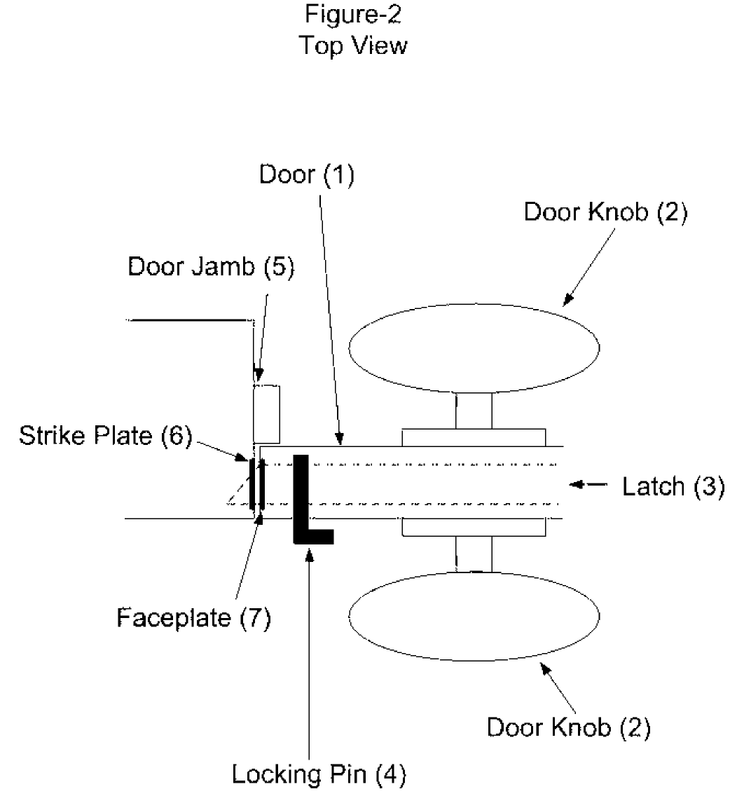

This invention describes a device (locking pin) that attaches to a door preventing the door from being opened from the outside. This invention applies to doors that open and close by turning a door knob (or pressing the lever of a lever handle) which slides a latch as well as deadbolt latches (either operated by turning a key or a handle). For the rest of this document, door knob, handle and lever handle will refer to the same thing. The intent of the invention is to prevent the movement of the latch so that the only way to open the door is to remove the device. See FIG. 1 and FIG. 2 showing an example of a latch (3) operated by a door knob (2). Once the locking pin (4) is in place, the latch (3) cannot slide back into the door (1). If the door (1) was closed and the latch (3) was through the strike plate (6) on the door jamb (5) and the locking pin (4) was inserted, the door could not be opened until the locking pin was removed.

The device is comprised of a material able to withstand the force applied by the sliding latch when a door knob is being turned to open the door or the force applied by the sliding latch when turning a key to open a deadbolt lock. Brass or steel would be examples of suitable materials for the device but not the only types of material.

Some advantages of this device are the following:
1. It works on deadbolt locks.
2. It can be manufactured to blend in with existing door hardware and can therefore be aesthetically pleasing.
3. Installation of the device is simple.
4. Works on a variety of door thicknesses simply by changing the length of the locking pin.

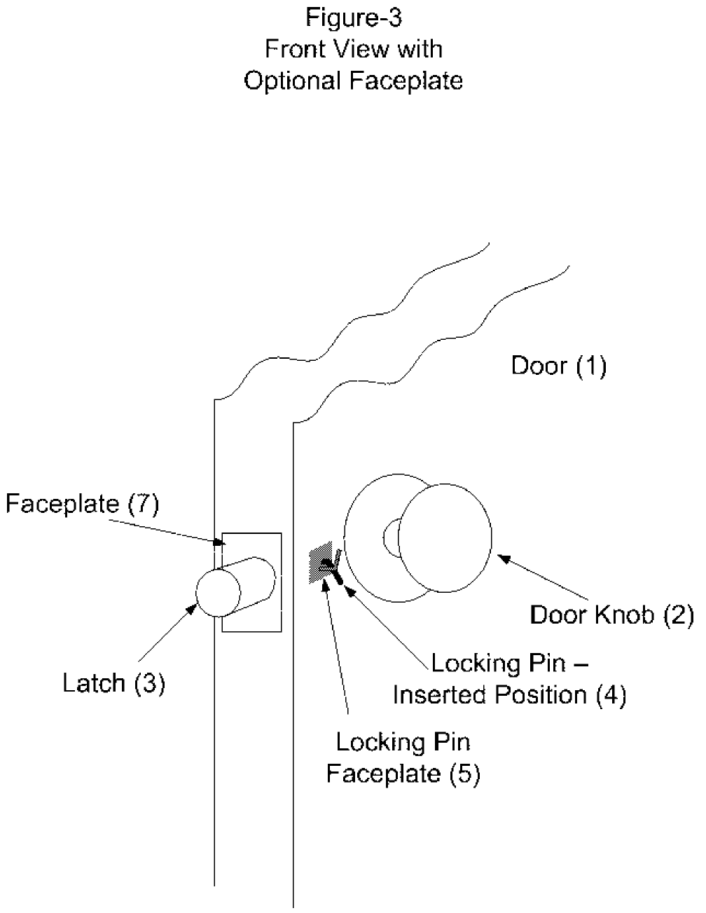

In FIG. 3 there is an optional device (5) called a locking pin faceplate which can accompany the locking pin serving both a cosmetic and functional purpose. The faceplate would attach to the door and the locking pin would slide though a hole in the faceplate and the door. A small hook on the faceplate would help keep the locking pin securely in place.

What is claimed is:

1. A door lock security device that slides through a hole on the interior side of a door and through the door latch but not so far as to extrude through the exterior side of the door, thereby preventing the door from being opened from the outside.

2. A door lock security device as described in claim 1 comprised of a material able to withstand the force applied to it when opening the door by turning a door knob.

3. A door lock security device as described in claim 1 comprised of a material able to withstand the force applied to it when turning a key to open a lock.

4. A method of inserting a locking pin through a door latch, thereby preventing the door from being opened from the outside.
